(19) United States
(12) Patent Application Publication
(10) Pub. No.: US 2026/0243897 A1
(43) Pub. Date: Aug. 20, 2026

(54) METHODS, SYSTEMS, AND COMPUTER READABLE MEDIA FOR DEPTH EXTRACTION USING DIFFRACTIVE STRUCTURED LIGHT AND EVENT-BASED CAMERA

(71) Applicant: The Trustees of the University of Pennsylvania, Philadelphia, PA (US)

(72) Inventors: Konstantinos Daniilidis, Wynnewood, PA (US); Kenneth Parker Chaney, II, Philadelphia, PA (US)

(21) Appl. No.: 19/640,097

(22) Filed: Apr. 6, 2026

Related U.S. Application Data
(60) Provisional application No. 63/783,383, filed on Apr. 4, 2025.

(51) Int. Cl. G01S 17/42; G01S 17/89; G06T 7/521; H04N 25/47

(52) U.S. Cl. CPC G01S 17/42; G01S 17/89; G06T 7/521; H04N 25/47; G06T 2207/10028

(57) ABSTRACT

A method for depth extraction using diffractive structured light and an event-based camera includes projecting a plurality of channels of diffractive structured light into a scene, each channel including a plurality of Fraunhofer copies resulting from passing light from a light source through a diffractive optical element. The method further includes detecting, using an event-based camera, light reflected from the scene. The method further includes determining depth measurements of the scene from the light detected by the event-based camera using a processing pipeline calibrated using minimum and maximum depth constraints for each channel to disambiguate the Fraunhofer copies in the light detected by the event-based camera.

### PRIORITY CLAIM

This application claims the benefit of priority of U.S. Provisional Patent Application No. 63/783,383, filed Apr. 4, 2025, the disclosure of which is incorporated herein by reference in its entirety.

### TECHNICAL FIELD

The subject matter described herein relates to extracting depth information from a scene using structured light. More particularly, the subject matter described herein relates to depth extraction using diffractive structured light and an event-based camera.

### BACKGROUND

Structured light depth extraction systems project patterns of light from a projector into a scene, detect light reflected from the scene using a camera, and determine depth information for objects in the scene by mapping the detected light patterns to the projected light patterns and given the locations of the camera and the projector relative to the scene. Structured light depth extraction systems can be used in environments requiring high-speed depth resolution, such as virtual and augmented reality environments.

Event-based cameras have been used in structured light depth extraction systems to increase the speed at which depth information can be determined over that of systems that use frame-based cameras. An event-based camera records changes in intensity of individual pixels and timestamps the changes. A frame-based camera records average changes in intensity of all of the pixels on the camera sensor during a frame time.

Using an event-based camera, the projector speed becomes a limiting factor on the speed of acquiring depth information. Using diffractive optical elements in a structured light projector increases the speed at which different patterns can be projected into the scene. Depth resolution in a diffractive structured light system involves identifying projected patterns in the images detected by the camera. The projected patterns in a diffractive structured light system can include patterns of repeating lines resulting from passing coherent light through slits in the diffractive optical element. These lines are referred to as Fraunhofer copies. Identifying projected Fraunhofer copies in patterns detected by a camera is a challenging problem, especially when the goal is increasing the speed of the depth resolution.

Accordingly, there exists a need for improved methods, systems, and computer readable media for depth extraction in structured light systems that use a diffractive optical element and an event-based camera.

### SUMMARY

The subject matter described herein includes a method for depth extraction using diffractive structured light and an event-based camera. The method includes projecting a plurality of channels of diffractive structured light into a scene, each channel including a plurality of Fraunhofer copies resulting from passing light from a light source through a diffractive optical element. The method further includes detecting, using an event-based camera, light reflected from the scene. The method further includes determining depth measurements of the scene from the light detected by the event-based camera using a processing pipeline calibrated using minimum and maximum depth constraints for each channel to disambiguate the Fraunhofer copies in the light detected by the event-based camera.

According to another aspect of the subject matter described herein, projecting the plurality of channels of diffractive structured light into the scene comprises, for each channel, passing coherent light through the diffractive optical element to produce the Fraunhofer copies.

According to another aspect of the subject matter described herein, the Fraunhofer copies comprise lines visible in the diffractive structured light formed by passing the coherent light through slits in the diffractive optical element.

According to another aspect of the subject matter described herein, detecting the light reflected from the scene includes detecting the light synchronously with projection of the light for each of the channels.

According to another aspect of the subject matter described herein, the processing pipeline includes a Fraunhofer copy lookup table that enables the Fraunhofer copies to be identified in the light reflected from the scene and a depth lookup table that contains depth values corresponding to coordinates of the identified Fraunhofer copies.

According to another aspect of the subject matter described herein, determining the depth measurements includes computing refined depth measurements by comparing events occurring at pixels at corresponding spatial locations in different channels.

According to another aspect of the subject matter described herein, a system for depth extraction using diffractive structured light and an event-based camera is provided. The system includes a structured light projector including a light source and a diffractive optical element for projecting a plurality of channels of diffractive structured light into a scene, each channel including a plurality of Fraunhofer copies resulting from passing light from the light source through the diffractive optical element. The system further includes an event-based camera for detecting light reflected from the scene. The system further includes a processing pipeline for determining depth measurements of the scene from the light detected by the event-based camera, wherein the processing pipeline is calibrated using minimum and maximum depth constraints for each channel to disambiguate the Fraunhofer copies in the light detected by the event-based camera.

According to another aspect of the subject matter described herein, the structured light projector is configured to, for each channel, pass coherent light through the diffractive optical element to produce the Fraunhofer copies.

According to another aspect of the subject matter described herein, the Fraunhofer copies comprise lines visible in the structured light formed by passing the coherent light through slits in the diffractive optical element.

According to another aspect of the subject matter described herein, the event-based camera is configured to detect the light synchronously with projection of the light for each of the channels.

According to another aspect of the subject matter described herein, the processing pipeline includes a Fraunhofer copy lookup table that enables the Fraunhofer copies to be identified in the light reflected from the scene and a depth lookup table that contains depth values corresponding to coordinates of the identified Fraunhofer copies.

According to another aspect of the subject matter described herein, the processing pipeline is configured to compute refined depth measurements by comparing events occurring at pixels at corresponding spatial locations in different channels.

According to another aspect of the subject matter described herein, a non-transitory computer readable medium having stored thereon executable instructions that when executed by a processor of a computer control the computer to perform steps is provided. The steps include controlling a structured light projector to project a plurality of channels of diffractive structured light into a scene, each channel including a plurality of Fraunhofer copies resulting from passing light from a light source through a diffractive optical element. The steps further include controlling an event-based camera to detect light reflected from the scene. The steps further include determining depth measurements of the scene from the light detected by the event-based camera using a processing pipeline calibrated using minimum and maximum depth constraints for each channel to disambiguate the Fraunhofer copies in the light detected by the event-based camera.

According to another aspect of the subject matter described herein, controlling the structured light projector to project the plurality of channels of diffractive structured light into the scene comprises controlling the structured light projector to, for each channel, pass coherent light through the diffractive optical element to produce the Fraunhofer copies.

According to another aspect of the subject matter described herein, controlling the event-based camera to detect the light reflected from the scene includes controlling the event-based camera to detect the light synchronously with projection of the light for each of the channels.

The subject matter described herein can be implemented in software in combination with hardware and/or firmware. For example, the subject matter described herein can be implemented in software executed by a processor. In one exemplary implementation, the subject matter described herein can be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Examples of the subject matter described herein will now be explained with reference to the accompanying drawings, of which:

FIG. 1 is a graph illustrating trade-offs between resolution, latency, and efficiency in structured light depth extraction systems;

FIG. 2 is a diagram illustrating an example multi-stage processing pipeline for determining depth measurements from events detected by an event-based camera;

FIG. 3 is a diagram illustrating example Fraunhofer copy ambiguity and example depth constraints for disambiguating Fraunhofer copy assignment;

FIG. 4 is a diagram illustrating example depth estimation results generated using different stages of the processing pipeline;

FIG. 5 is a diagram illustrating example depth estimation results for dynamic scenes;

FIG. 6 is a diagram illustrating example improvements in disparity estimation using an event-aware multi-path matching technique;

FIG. 7 is a block diagram illustrating an exemplary system for structured light depth extraction using an event-based camera; and

FIG. 8 is a flow chart illustrating an exemplary process for structured light depth extraction using an event-based camera.

### DETAILED DESCRIPTION

The subject matter described herein includes a system for depth extraction using diffractive structured light, an event-based camera, and a processing pipeline calibrated with depth constraints for each channel to extract depth information by disambiguating Fraunhofer copies in the detected structured light patterns.

### 1. INTRODUCTION

Depth estimation is a cornerstone of modern technological advancements, fueling progress in fields ranging from industrial automation and safety to the immersive experiences offered by virtual and augmented reality. The precision of depth estimation and the speed at which it can be executed play a pivotal role in the effectiveness of these technologies. However, achieving optimal balance between these two factors is a persistent challenge.

A variety of methods exist for depth estimation, ranging from passive multi view solutions, such as stereo [31] and neural estimation to active solutions, such as LiDAR, ToF [20], and structured light systems. Passive solutions require consistent features to enable matching within the scene or priors. Active solutions facilitate operation in more arbitrary environments, where features may not be readily available for matching. LiDAR and ToF sensors have high operating frequencies but often low spatial resolution. Structured light systems provide high resolution depth maps but struggle to achieve high operating frequencies due to sampling limitations.

Structured light systems project a known pattern from an active projector element and observe the scene from a passive camera element. The joint actions and observations are then used to fully estimate the structure of the scene. Structured light methods are fast and accurate through the construction of the projected patterns enabling depth to be estimated through purely local observations. This is achieved by encoding unique information into the projection [38].

The simplicity and efficiency of these solutions have led to many commercial products such as the Kinect V1 [42], Apple FaceID [1], and Intel RealSense [34].

Despite their advantages, structured light systems grapple with limitations imposed by the projector's bandwidth and the observer's sensitivity. This is where event-based cameras come into play, offering a solution to the inherent latency in traditional sensor sampling [12]. An event-based camera operates with asynchronous independent dynamic pixels to report changes in the scene [12]. By operating asynchronously, these cameras efficiently detect changes in the scene from the projector illumination, dramatically reducing unnecessary data processing and energy consumption.

Most standard projectors operate through a raster scanning pattern which illuminates a single pixel at any moment in time. This naturally pairs with a traditional frame-based camera where the observation window can be synchronized and averaged across the raster scanning process. While a traditional frame-based camera is synchronized and averages the observation across the frame window, an event-based camera has enough temporal resolution to observe the activation of each projector pixel. All other factors in the system being equal, the limiting factor becomes the projector itself.

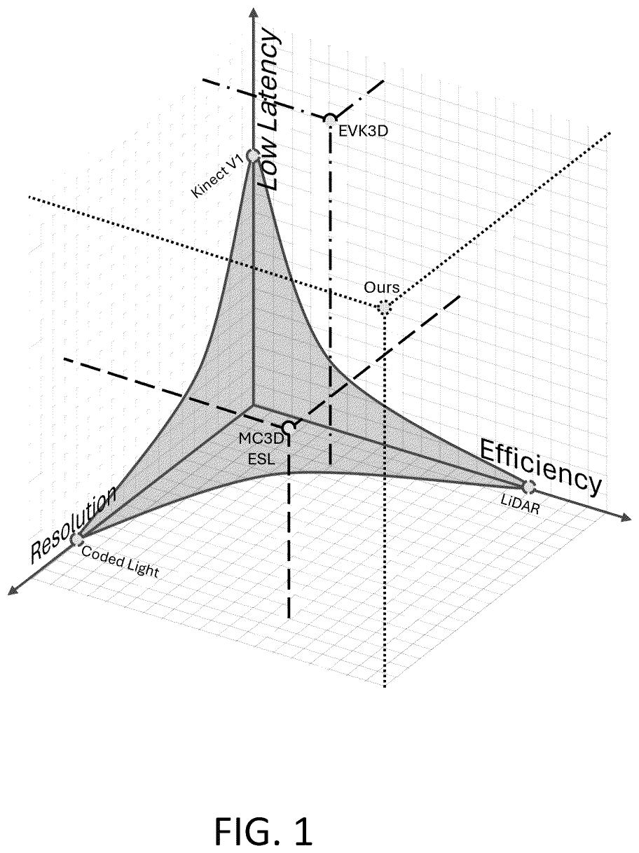

FIG. 1 is a graph illustrating tradeoffs between resolution, latency, and efficiency. Structured light systems exist with trade-offs between resolution, latency, and efficiency. Traditionally, these systems are constrained to strict trade-off bounds as illustrated by the red region, but MC3D [26] and ESL [29] showed using event-based cameras escapes this common trade-off paradigm. EVK3D from Prophesee provides ultra-low latency with a smaller resolution. Our method expands upon these by providing a high resolution, low latency, and sample efficient system.

Replacing the traditional raster scanning pattern of a projector with a diffractive optical element shifts from a large number of individually controlled small pixels to a small number of individually activated patterns. Making this change allows for high scene coverage with less complexity in the control of the projector. This pattern is illuminated at the same moment in time, and the disambiguation of the signal becomes the challenging task, which requires additional constraints or a more global context.

This work provides a high speed structured light system by combining the event-based cameras and a diffractive optical projector. We exploit the advantages of both of these systems to provide a high resolution and high temporal fidelity depth estimation while mitigating the computational costs often associated with such operation.

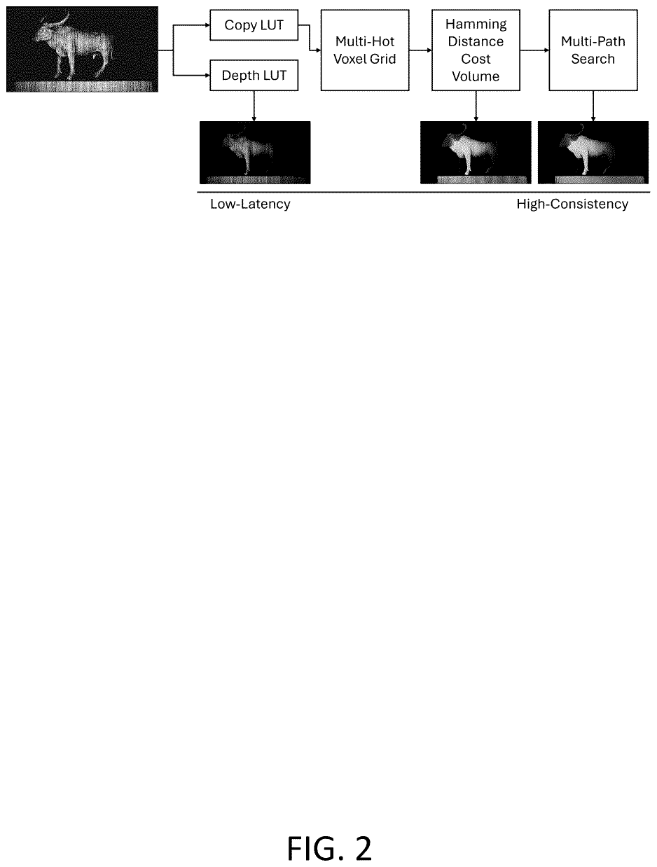

FIG. 2 illustrates that our multi-stage processing pipeline allows for optimizing between latency and consistency. The LUT subsystem enables faster than real-time depth estimation regardless of the acquisition speed. Constructing a voxel grid regularizes the events and reduces redundant information. The cost volume can be used in either a greedy match or a multi-path search.

Early works [26, 29] showed the potential of these systems in fast single-point formulations. However, this system was constrained by the projector itself, resulting in an underutilized event-based camera. Instead, we propose to utilize a fast diffractive optical projector and exploit its properties to provide a fast and updatable depth estimation method. To this end, a secondary disparity constraint is introduced to allow for trivial depth estimates as well as a dynamic feature space to allow sub-frame depth estimations.

Example features of the subject matter described herein include:
A novel constraint for a diffractive structured light system to disambiguate Fraunhofer copies.
A novel formulation for depth estimation from an event-based camera with a diffractive structured light projector. We model this problem with a common feature space for both the observing event camera and the diffractive structured light projector.
A method providing two operating modalities to allow trade-offs in precision and latency: either a sparse event-by-event depth lookup table that can run at projector rate (40 kHz) or slower, or more precise frame consistent depth estimates through the greedy matching or multi-path methods.

### 2. RELATED WORK

2.1 3D Reconstruction with Event-Based Cameras

The sparse and asynchronous nature of event-based cameras leads to challenges in 3D reconstruction as existing frame-based algorithms cannot be directly applied. Traditional monocular reconstruction requires motion to create observations that can be used to recover depth [37]. This method of motion stereo extends naturally to event-based cameras [8, 18, 32] as motion is required for the generation of events. Reconstruction of individual objects requires exploration of the object itself; E3D [4] showed the necessary information was contained in the event stream through reconstruction of images and deploying PMO [24] for mesh optimization. EvAC3D [40] estimates the structure of an observed object by carving the silhouette in continuous time. While the motion stereo extends naturally, static stereo itself does not. In event cameras, motion is needed to receive data to process. Therefore, stereo event camera systems must handle motion and disparity estimation simultaneously [43, 44].

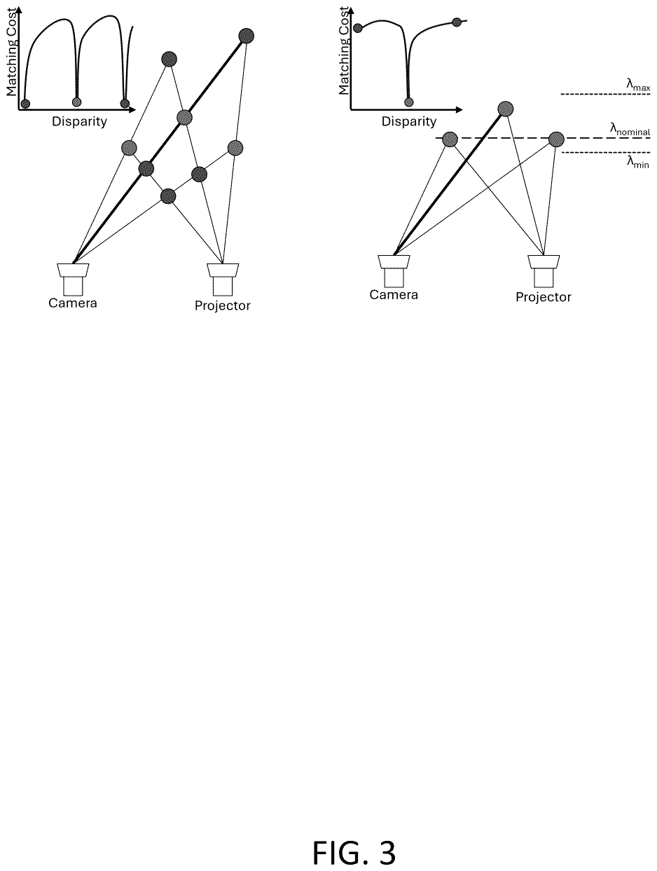

FIG. 3 illustrates that observations from the camera can be mapped to multiple Fraunhofer copies in an unconstrained system. (left) Three copies and three observations are seen with points mapping their potential depths. This ambiguity can also be seen in the matching cost for the bolded center line where there are three minimums. (right) Labeled virtual planes that represent the nominal as well as the min and max depths. These virtual planes enable the disambiguation of the copy assignment problem which also benefits the matching systems.

### 2.2 Event-Based Structured Light

Event-based cameras are sensors well suited for concentrated structured light systems. Fixed pulsed laser lines [7] concentrate the scan to a fixed plane in front of the system but provide low latency feedback. This system is optimal for mapping with known dynamics to aggregate over time (e.g., topographical mapping). The advantage of event-based cameras is sparse asynchronous sampling, effectively removing the sampling cost for any single sample. Without sample time considerations, scanning a single point laser across the scene becomes feasible as the sample time is negligible. MC3D correlates the time of actions on the projector to the time of observations from the event camera. This direct correlation leads to ultra low latency event-by-event calculations but suffers from noise since no neighboring information is considered in MC3D. ESL [29] provides a framework to compensate for these errors by utilizing a time feature.

TABLE 1
Operational comparisons between methods. Resolution of the resulting point
cloud after one full update. Full depth frame frequencies are shown for
all methods; update rates are listed where partial updates are available.

| | | Event | | | | | | |
|---|---|---|---|---|---|---|---|---|
| Method | Task | Camera(s) | Resolution | Projector | Full | | Partial | |
| Brandli [7] | Depth | DVS128‡ | 1 × 128 | Laser Line | 500 | Hz | — | |
| Leroux [21] | Depth | ATIS | 20 × 30 | DLP | 20 | Hz | — | |
| MC3D [26] | Depth | DVS128‡ | 128 × 128 | Laser Point | 60 | Hz | 250 | Hz |
| EvRGB-SL [3] | RGB | Gen3-VGA† | 640 × 480 | DLP | 30 | Hz | 1 | kHz |
| EVK3D†* | Depth* | IMX636†* | 24 × 48* | VCSEL + DOE* | 500 | Hz* | 4 | kHz* |
| ESL [29] | Depth | Gen3S1.1† | 640 × 480 | Laser Point | 60 | Hz | — | |
| Ours | Depth | IMX636† | 1280 × 720 | VCSEL + DOE | 1.25 | kHz | 40 | kHz |

†Prophesee sensor.
‡IniVation sensor.
*Provided by Prophesee Support Knowledge Center window during the optimization procedure. The trade-off is that the latency is bound to the full frame of the projector, but the latency for a full frame is the same between MC3D and ESL. Calibration of such systems relies upon a dual plane method that assumes a regular grid of laser pulses producing a regular grid of events and matching timestamps [39]. Updates to the depth estimates can be broken into two categories: full scan updates and partial updates. The full scan updates are driven by the choice in projector while the partial updates are driven by the algorithm implemented. Table 1 shows these comparisons as they relate to each work.

Encoding the structure into a single observation allows for low latency, but often at the cost of being susceptible to noise. Encoding of the projection into a high frequency signal allows for fast depth with confirmation that an event was generated by the projector [21]. Given sufficiently accurate timestamps, the phase of a signal [23, 25] can also be used to encode this depth information. This phase information comes as a local time difference between a reference sequence and the currently measured sequence [25, 26]. These systems require a known reference pattern to compute local relative depth. The utility of reference patterns depends on the ability to capture the pattern in an environment with a noise profile similar to that of the deployed environment, which is not always possible.

Fast structured light was previously explored with event-based cameras through the use of RGB projectors to identify reflectance levels [3,28]. These works utilize a digital light projector in a single bit mode to produce RGB images at speeds of around 1 kHz. While sampling for color does not require any global information, smart sampling must be performed to ensure redundant data is not collected. In this work, we achieve the same update rates for depth estimation as previous works that estimated RGB intensity. Depth estimation requires structure estimation in addition to instantaneous responses.

### 2.3 Structured Light Projectors

The underlying algorithms for structured light systems depend heavily upon the capabilities of the projector being used. Dense structured light systems rely upon a conventional projector to project a sequence of frames that encode a projector position into light that will be observed by a camera [33, 36]. This allows for flexibility in the sampling time and encoding mechanism. Laser based systems allow for high concentration of light for more accurate readings at the cost of needing more sample to provide sufficient coverage of the scene. These are systems at opposite sides of the light distribution ratio and sample per depth estimate metrics.

The Kinect V1 [42] creates a pattern of spatial codes that can be locally decoded to extract depth. A pseudorandom code can be applied to a dot pattern in the projector [27] and decoded into depth from observations in the camera. The code location can be discovered in the camera frame by checking a patch. This process reduces the density of depths that can be computed. In the Intel RealSense [34], this resolution limit is overcome by adding a stereo computation on top of the structured light. A regular grid of dots allows for local depth to be determined against a measured reference [22], but not absolute depth as there would be global ambiguities. FIG. 1 shows the trade-offs in structured light systems in comparison to event-based structured light systems.

### 3 SETUP

### 3.1 Event-Based Camera

Event-based cameras offer a high temporal resolution that can capture high fidelity illumination and motion. Event entanglement occurs when these event sources operate simultaneously. The disentanglement of event sources is a challenging task that is actively being researched [41]. These methods often rely upon expensive networks for inference or other optimization methods. In the case of a high-frequency structured light projector, the disentanglement problem can be looked at as applying a band-pass filter to the frequencies that are expected. The IMX636 from Prophesee has recently enabled expanded bias configuration utilities to operate outside of the standard operational ranges. This extended bias allows for tuning to replicate a band-pass filter to match the projector frequency through the tuning front end buffer response bandwidths. The event rate can be further tuned with the contrast threshold to avoid saturation from the projector.

The front end buffer filters can be tuned to the high-frequency signals that the projector creates. Creating a band-pass around the signal frequency expected to be created by the projector enables the removal of other signals. Natural motions from the camera or passing foreground objects are unlikely to approach this high frequency and thus would be removed by the analog processing in each pixel.

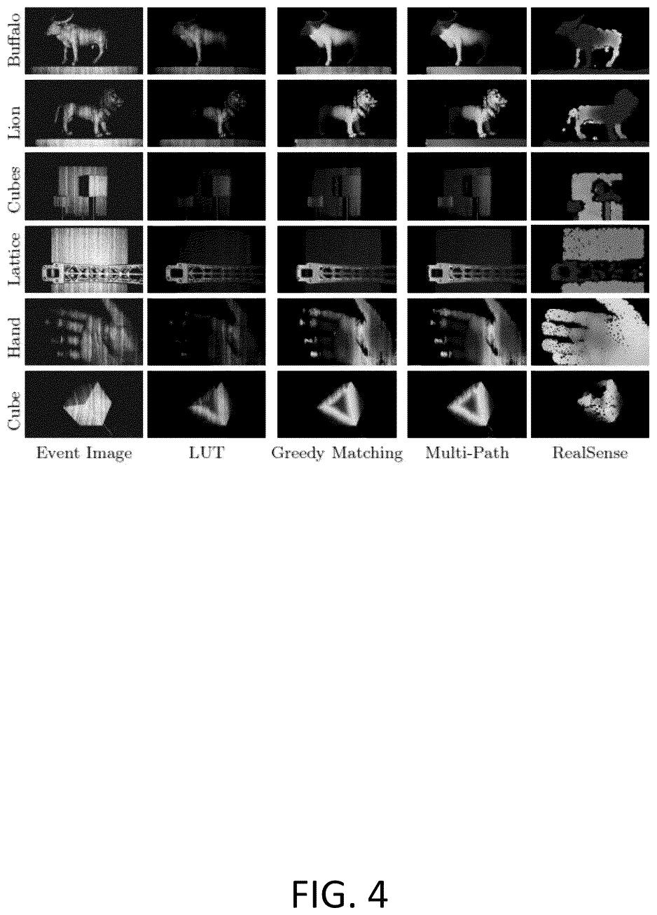

FIG. 4 illustrates depth estimate results from each stage of the processing pipeline. The LUT can be seen to provide global consistency but lacks the surface smoothness. The greedy matching and multi-path methods show greater local consistency in surface smoothness but sometimes miss global details. The Intel RealSense data was captured for qualitative comparisons only as it was cropped from the original resolution of the sensor. For object centered scenes, the visibility coverage provides an estimate of the object coverage. The visibility coverage from the Intel RealSense is on average 27%. The LUT on average is a sparser representation at 18%. Greedy matching and multi-path matching both improve upon this with an average coverage of 31% through the use of local patch information. FIG. 4: Depth estimate results from each stage of the processing pipeline.

### 3.2 Projector

Fast projection across a scene was achieved using a custom diffractive optical pattern. This pattern projects parallel lines when illuminated by a coherent light source creating a fringe photogrammetry type setup [17]. Moving the pattern is accomplished through a set of coherent VCSEL sources that are individually controllable.

Diffractive Optics The choice of optics within a projection system impacts the sampling and light efficiency of the system as a whole. Traditional optical elements project a single point within a sensor to a single point in the world. Diffractive optical elements on the other hand can take a single point within the sensor and map it to many points, lines, or other surfaces on the external world. This change in projection methodology requires fewer actions to scan a scene compared to a traditional projector. Repeated vertical slits cause an interference pattern creating evenly spaced vertical lines projected into the world. We refer to each of these vertical lines as Fraunhofer copies, βi. These Fraunhofer copies receive an index relative to the central mother copy β0, such that β−1 would be to the immediate left and β1 to the immediate right. The pattern as a whole can be shifted through changing the coincidence angle of the light with respect to the inside surface of the diffractive element. FIG. 3 shows the Fraunhofer copies projected onto the scene along with the ambiguity introduced by the uncertainty in the Fraunhofer copy assignment. VCSEL VCSELs have become a commodity within projection systems due to their ease of manufacturing and ability to be created in 2D arrays [35]. Diffractive optics require coherent light, which is readily produced by appropriately manufactured VCSELs [2]. Power efficiency and bandwidth are the two primary properties that are important for applications with event-based cameras [13]. Multiple VCSELs operating independently create discrete channels, αᵢ, and steering patterns to illuminate the scene through a diffractive optic. Neighboring channels, αᵢ₋₁, αᵢ, aᵢ₊₁, locally encode information into the light sequence. Channels are encoded into the event stream through timestamp association with the current channel and the next: [T_{αi}, T_{αi+1}).

### 4 METHOD

The proposed method relies upon three primary factors: global uniqueness, local texture, and local consistency. These three factors enable an increasingly accurate estimate of depth by refining the previous stage in the pipeline. These are three general concepts in stereo and structured light systems. In our system they are accomplished through Fraunhofer copy disambiguation, channel feature construction, and a multi-path search. The interaction of these parts is shown in FIG. 2.

### 4.1 Fraunhofer Copy Disambiguation

Fraunhofer copy assignment is a challenging problem due to the ambiguous nature of any individual observation. FIG. 3 illustrates the multiple assignment problem in the left pane. The assignment problem is reduced by the addition of minimum and maximum constraints on the disparity space. These constraints create a unique mapping between the observations of the event camera and the Fraunhofer copies of the projector. Similar to the construction of general stereo algorithms, we employ an additional minimum disparity constraint limiting the maximum depth of an object. We formalize this construction utilizing a nominal plane depth, λₖ, of interest for a given scene. The diffraction calibration of the projector allows for the construction of a Fraunhofer copy lookup table. For a point xi that belongs to some channel di, and the nominal depth plane λ=λₖ.

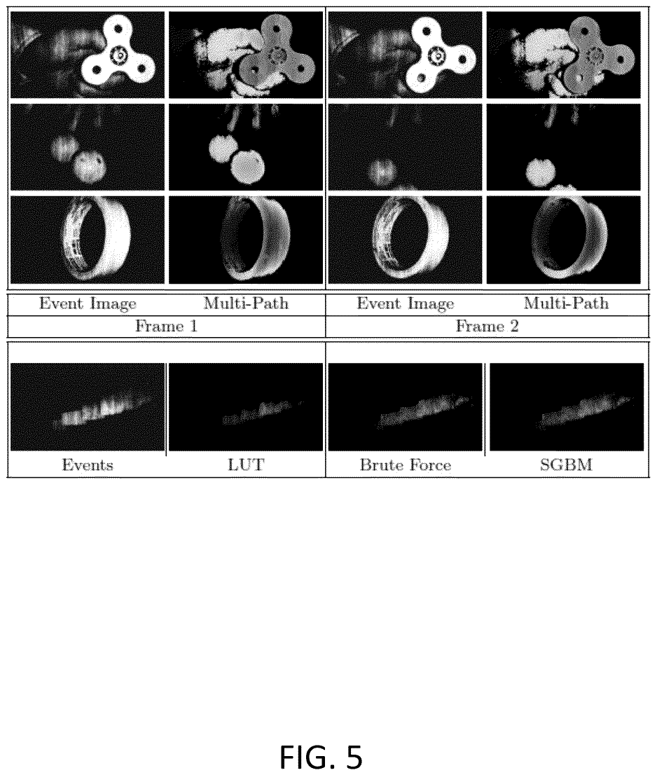

FIG. 5 illustrates results from dynamic objects. The decoupling of channels enables a consistent depth estimate through the scan of the scene. (Top) The spinner, ping pong balls, and tape spool were generated with the equivalent of 312 frames per second. (Bottom) A quadrotor blade close up spinning at 1700 RPM with generated depth images at 1250 Hz. The effects of the scanning pattern can be seen since the blade continues to move during the scanning process.

The best matching copy in all possible copies is obtained through the following cost function:

$${I}_{{λ}_{k}} ( {α}_{i} , {x}_{i} ) = {argmin}_{l} {min}_{y} {‖ {x}_{i} - {\prod }_{{α}_{i}} ( {T}_{c a m} , {T}_{proj} , {P}_{y}^{l} , {λ}_{k} ) ‖}_{2} \qquad ( 1 )$$

Since our channel labeling increases monotonically from left to right, the nearest neighbor differentiates between nearby copies. Here, we show the derivation of the allowed depth range for each nominal depth plane.

Boundary Constraints We denote these the calibrated points as coordinates in the projector frame as uₚ^{(α}^{ᵢ}^{,β}^{ⱼ}^{}} and uₚ^{(α}^{ᵢ}^{,β}^{ⱼ₊₁}^{}}. Assuming a rectified stereo configuration with baseline, b, these points can be written as:

$${u}_{c}^{\{ {α}_{i} , {β}_{j} \}} = {u}_{p}^{\{ {α}_{i} , {β}_{j} \}} + \frac{b}{{λ}_{k}} {u}_{c}^{\{ {α}_{i} , {β}_{j} + 1 \}} = {u}_{p}^{\{ {α}_{i} , {β}_{j} + 1 \}} + \frac{b}{{λ}_{k}} \qquad ( 2 )$$

The middle point of these two assumed points is

$${u}_{c}^{m i d} = \frac{{u}_{c}^{\{ {α}_{i} , {β}_{j} \}} + {u}_{c}^{1}}{2} = {u}_{p}^{\{ {α}_{i} , {β}_{j} \}} + \frac{b}{{λ}_{right}} = {u}_{p}^{\{ {α}_{i} , {β}_{j} + 1 \}} + \frac{b}{{λ}_{left}} \qquad ( 3 )$$

We can solve the depth of the label boundary on the left and right:

$${λ}_{right}^{\{ {α}_{i} , {β}_{j} \}} = \frac{b}{{u}_{c}^{m i d} - {u}_{p}^{\{ {α}_{i} , {β}_{j} \}}} {λ}_{left}^{\{ {α}_{i} , {β}_{j} + 1 \}} = \frac{b}{{u}_{c}^{m i d} - {u}_{p}^{\{ {α}_{i} , {β}_{j} + 1 \}}} \qquad ( 4 )$$

The discretization of spatial points on the sensor allows for this to be pre-computed for each channel of the projector into a lookup table. The lookup table provides a high-throughput method to associate a copy and depth with each event.

LUT Depth Error The boundary constraints inform of the maximum depth error that can be accrued by using the LUT directly. The LUT was generated with the assumption that the thickness, δ of the laser line is one pixel wide, however in practice this is not the case and computing the center of the line is non-trivial as spatially correlated events are not necessarily coherent across memory access. The maximum error that can be expected for a given event would then be.

$${λ}_{e r r o r} = max ( {I}_{zk} ( {x}_{i} ) - {I}_{z k} ( {x}_{i} - δ ) , {I}_{z k} ( {x}_{i} ) - {I}_{z k} ( {x}_{i} + δ ) ) \qquad ( 5 )$$

### 4.2 Multi Channel Feature

The pattern from the diffractive optical element creates lines with an angular thickness. Neighboring channels create overlapping patterns through changing the coincidence angle by a small amount. Importantly, the change in coincidence angle is less than that of the thickness of the line itself. This creates an interleaved pattern of diffraction patterns where the overlap gives higher spatial texturing. Prior methods [28, 29] utilize a time surface for matching between a projector and event-based camera. Utilizing a time surface would cause wrong assignments between observation and copies. FIG. 3 illustrates the multiple cost minimums that are caused due to wrong assignments. A union of one-hot vectors containing the observations from each event at a pixel creates a sparse updatable feature when given more information. To construct the feature vector for an individual pixel given a set of N events that are on the same pixel, ei=(x₀, y₀, tᵢ, pᵢ,)_{i∈[1,N]}. We first find the channel and copy information:

$${α}_{i} = {α}_{a} ∍ {t}_{i} ∈ [ {T}_{{α}_{α}} , {T}_{{α}_{α + 1}} ] \qquad ( 6 )$$

$${β}_{i} = {LUT}_{copy} ( {α}_{i} , {x}_{0} , {y}_{0} )$$

A feature f that has separated channel information can be constructed:

$${f}_{x , y} ( α , β ) = {\prod }_{i} \text{?} ( α = {α}_{i} ) \text{?} ( β = {β}_{i} ) \qquad ( 7 )$$

The separation of channels in the feature space allows for a new event, eⱼ, to update the feature space.

$${f}_{x , y} ( {α}_{j} ) = [ \text{?} ( {β}_{j} = 0 ) … \text{?} ( {β}_{j} = n ) … ] \qquad ( 8 )$$

The distance between two features needs to accommodate for the sparseness of the sensor and the noise expected. Often, the noise that we have is the lack of an event where one is expected. The lack of data should not be penalized in the same manner as the presence of conflicting data. The union of one-hot vectors allows for the hamming distance to be used as a distance metric for these features. This distance will penalize the mismatch in information more than the lack of information. For two features, Y and Z, the distance can be computed as:

$$HD ( Y , Z ) = {\sum }_{α} {\sum }_{β} \vert Y ( α , β ) - Z ( α , β ) \vert \qquad ( 9 )$$

This construction also has the added benefit of operating with methods used from hamming codes and other binary coded structures. Efficient implementations of the xor and popcnt instructions are ubiquitous across CPUs and GPUs.

### 4.3 Greedy Matching

With a feature space that produces robust and unique features across a frame, a greedy solution can be implemented to solve for the disparity between the camera and the projector feature grids. The common solution to this is to find the minimum distance between features across a set of possible disparities:

$$C ( x , y , d ) = HD ( E ( x , y ) , P ( x + d , y ) ) \qquad ( 10 )$$

$${d}_{x , y} ( E , P ) = {argmin}_{d} {\sum }_{i ∈ W} {\sum }_{j ∈ W} C ( x + i , y + j , d ) \qquad ( 11 )$$

For static scenes where projection from each channel lands on the same points in 3D space, a greedy solution provides correct results. The features used create globally consistent features, but due to noise and object movement may result in local inconsistencies in the cost.

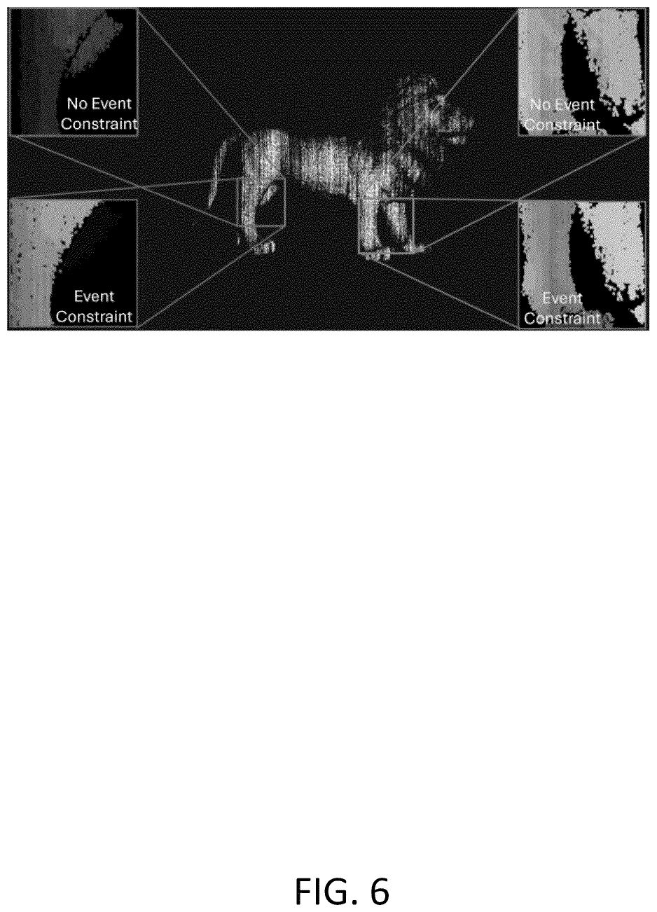

FIG. 6 illustrates improvements in the logical segments of the lion can be seen with close analysis of the legs. The top images show the original SGM implementation that is not event aware. The bottom images show an event aware SGM which has integrated the event penalty constraint. In both cases (outlined in green and blue), we see an improvement on the logical separation of the legs.

### 4.4 Multi-Path Matching

Our multi-path solution is based on semi-global matching [15, 16] which aggregates information from multiple directions to reach the pixel given a disparity. Consistency in disparity transitions is handled through tuning of P1 and P2 which handle jumps in disparity by one pixel and more than one pixel, respectively. The cost would become:

$${C}_{r} ( x , y , d ) = C ( x , y , d ) + min ( \begin{matrix}{C}_{r} ( x - {r}_{x} , y - {r}_{Y} , d ) \\ {C}_{r} ( x - {r}_{x} , y - {r}_{Y} , d - 1 ) + P 1 \\ {C}_{r} ( x - {r}_{x} , y - {r}_{Y} , d + 1 ) + P 1 \\ {argmin}_{i} {C}_{r} ( x - {r}_{x} , y - {r}_{Y} , i ) + P 2\end{matrix} ) \qquad ( 12 )$$

Balancing P1 and P2 provides smooth transitions between regions of high texture. These methods often struggle with large regions of low texture as there are not enough observations to constrain the potential paths. Introducing an event penalty constraint allows for sparsity in the calculation to be regained by restarting the path cost for contiguous sets of events.

$${C}_{r} ( x , y , d ) = C ( x , y , d ) + 1 ( ( x - {r}_{x} , y - {r}_{y} ) ∈ eN ) min ( \begin{matrix}{C}_{r} ( x - {r}_{x} , y - {r}_{Y} , d ) \\ {C}_{r} ( x - {r}_{x} , y - {r}_{y} , d - 1 ) + P 1 \\ {C}_{r} ( x - {r}_{x} , y - {r}_{y} , d + 1 ) + P 1 \\ {argmin}_{i} {C}_{r} ( x - {r}_{x} , y - {r}_{y} , i ) + P 2\end{matrix} ) \qquad ( 13 )$$

Table 2: Chamfer distance and surface normal consistency compared to ground truth meshes. Chamfer distance and surface normal consistency is one sided due to using a single viewpoint for data capture.

TABLE 2
Chamfer Distance (mm) ↓/Surface Normal Consistency↑ compared
to ground truth meshes.
Chamfer Distance (mm) ↓/Surface Normal Consistency↑

| Method\ | | | | |
|---|---|---|---|---|
| Model | Buffalo | Lion | Cube | Plate |
| LUT | 2.27/0.508 | 2.44/0.572 | 1.46/0.639 | 3.78/0.429 |
| Greedy | 1.46/0.741 | 1.91/0.706 | 1.31/0.591 | 1.83/0.911 |
| Multi-Path | 1.44/0.763 | 2.30/0.715 | 1.35/0.593 | 2.25/0.906 |

With this addition, it can be seen that Cr must only be updated for pixels that contain events. An active pixel with a trailing non-active pixel along the path r is no longer dependent on the path cost up to that point. Run times for the lion in FIG. 4 drop from approximately 11.6 seconds to 2.3 seconds through adding the event penalty constraint. Improvements in the logical segments of the lion can be seen in FIG. 6 with the addition of the event penalty constraint.

### 5 EXPERIMENTS

### 5.1 Hardware Setup

To the best of our knowledge, there is no hardware setup for a line-based diffractive optical projector and event-based camera where our method can be tested. A custom structured light system was created with an event camera and VC-SEL projector. Event Camera In our setup, we use an EVK4 camera with the IMX636 sensor at resolution of 1280×720. The selected lens produces a field of view of approximately 48°. The bias_hpf was found to be the most important and was maintained at 144. The remaining biases were tuned for static and dynamic scenes. Projector A custom projector was used that contains 32 VCSEL Channels, [α₀, α₃₁], and 11 vertical line Fraunhofer copies, [β₋₅, β₅]. The VC-SELs can be turned on at a maximum rate of 40 kHz, providing a maximum scan rate through each channel of 1.25 kHz. Calibration The calibration for the projector was provided by the manufacturer for each channel's response. Event camera intrinsic calibration was accomplished through image reconstruction [30] and Kalibr [11]. The extrinsics were calibrated through projection onto a known reference plane and pattern aligned through iteratively minimizing the distance of the reprojection and observations. The calibrated baseline was approximately 3.2 cm from the projector to the event camera.

### 5.2 Static

A primary advantage of structured light approaches for event-based cameras is the ability to operate in an entirely static scene through the generation of events by the projector. FIG. 4 shows qualitative results from a variety of scenes that were tested with Intel RealSense depth images provided as a comparison. The lattice inspection example shows that our method can handle holes within objects due to the global feature created during the copy assignment process. In contrast, the Intel RealSense is missing features and is unable to reconstruct the lattice properly. Quantitative results were collected using ground truth meshes, fit to the computed depth images through ICP [5]. One-sided chamfer and cosine similarity metric were used to evaluate the accuracy of the depth image. One-sided metrics are used to allow for the limited visibility of the structured light system (i.e., it cannot see the back of the object). The buffalo and lion from MOEC-3D [40] were used to represent a more complex 3D geometry, while a cube and plane were used to represent simple shapes. Table 2 shows that results are all within 4 mm of the ground truth surface geometry. The surface normals improve with the additional processing from both the greedy and multi-path. Errors from the LUT in the surface normals are mainly due to the high frequency errors as explained in section 4.1. The static scenes were recorded with a 250 us channel time creating an 8 ms frame (e.g., 125 fps).

### 5.3 Dynamic

Dynamic scenes were generated with common objects to illustrate common object centric motions in front of the system. FIG. 5 shows three sequences of a fidget spinner spinning, ping pong balls being dropped, and a tape spool being spun. These recordings were generated with a 100 us channel time creating a 3.2 ms frame time (or 312 Hz). The noise level increased relative to the static scenes due to the lower signal put out by the projector (mainly impacting the edges of objects or surface normals that do not reflect the light sufficiently). The limits of the realized setup can be seen at the bottom of FIG. 5 with a quad rotor blade spinning at 1700 RPM. We were able to achieve a 25 μs channel time which is 800 μs frame time (1250 Hz).

### 6 CONCLUSION

In this work, we present a novel formulation for an event-based structured light system. At the core, this method is comprised of a Fraunhofer copy ambiguity reduction through a well understood geometric construction which enables fast and accurate depth estimates to be computed. The greedy matching and multi-path search methods were shown to increase the accuracy of the computed depth maps. We show that dynamic objects can take advantage of the 25 μs update rates that are provided by the projector system, allowing for a full depth image generation at 1.25 kHz.

Limitations There are two primary system limitations as presented: algorithm speed and bounding of errors. The system was implemented in Python and C++ with a pybind11 binding for speed critical components. The lookup table was trivially able to keep up with the event rate presented even with a python implementation. Greedy matching and multi-path matching on the other hand were limited to 10 Hz and 0.4 Hz for a cost volume considering 60 disparities. The fundamentals of these methods rely upon well understood methods and have significantly faster implementations on CPU [6] as well as on GPUs [14] and ASICs [9]. These faster implementations would help realize the full benefit of sampling rate of the projector and camera combination. The errors in the greedy and multi-path methods are not bounded in the same way that the errors in the LUT based method are bounded. This allows them to handle noise and local neighborhood information, but sometimes at the cost of some outliers.

### Exemplary System and Method

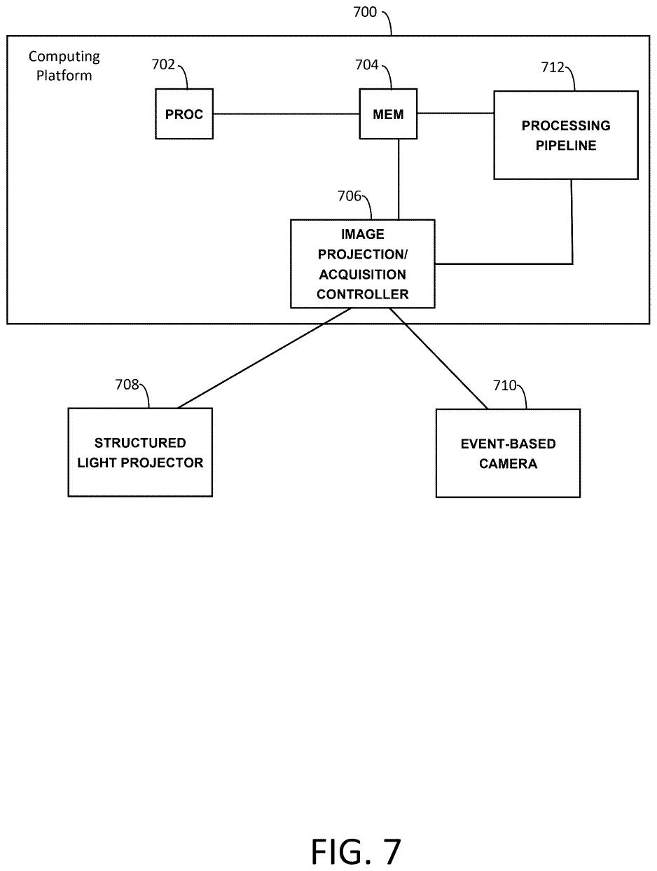

FIG. 7 is a block diagram illustrating an exemplary system for structured light depth extraction using an event-based camera. Referring to FIG. 7, the system includes a computing platform 700 including at least one processor 702 and memory 704. An image projection/acquisition controller 706 controls a structured light projector 708 to project structured light patterns onto a scene and controls an event-based camera 710 to acquire images resulting from the projection of the structured light patterns onto the scene. A processing pipeline 712, which may include an architecture similar to that illustrated in FIG. 2 receives the images and the projected structured light patterns and determines depth information for the scene. Image projection/acquisition controller 706 and processing pipeline 712 may be implemented using computer executable instructions stored in memory 704 and executed by processor 702.

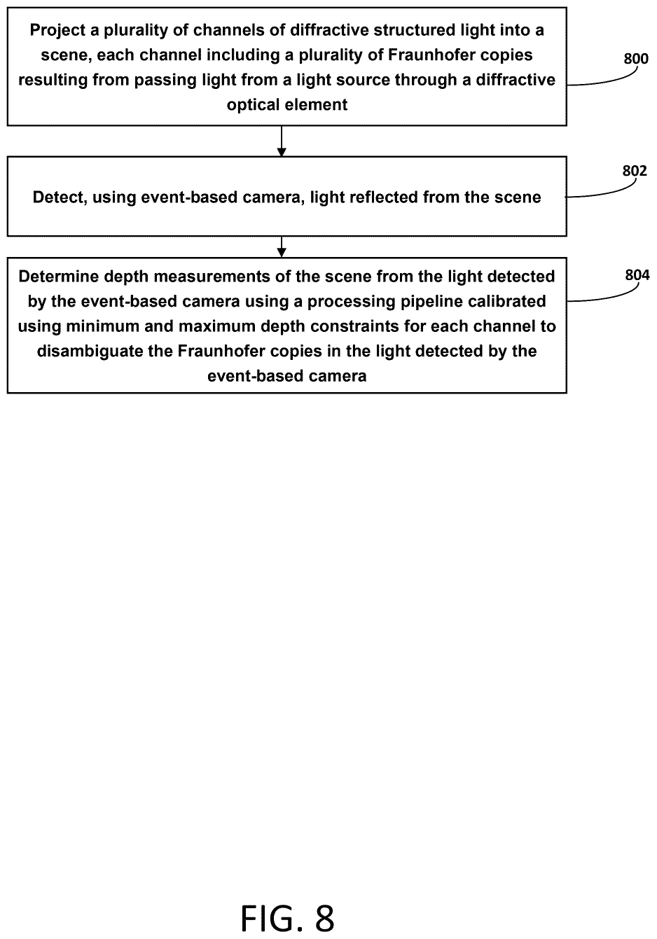

FIG. 8 is a flow chart illustrating an exemplary process for structured light depth extraction using an event-based camera. Referring to FIG. 8, in step 800, the process includes projecting a plurality of channels of diffractive structured light into a scene, each channel including a plurality of Fraunhofer copies resulting from passing light from a light source through a diffractive optical element. For example, image projection/acquisition controller 706 may control structured light projector 708 to project structured light patterns onto a scene. Projector 708 may include a diffractive optical element in the projection path that causes light passing from light source within projector 708 to form multiple Fraunhofer copies.

In step 802, the process further includes detecting, using an event-based camera, light reflected from the scene. For example, image projection/acquisition controller 706 may control event-based camera 710 to acquire images reflected from the scene.

In step 804, the process further includes determining depth measurements of the scene from the light detected by the event-based camera using a processing pipeline calibrated using minimum and maximum depth constraints for each channel to disambiguate the Fraunhofer copies in the light detected by the event-based camera. For example, processing pipeline 712 may perform Fraunhofer copy disambiguation using the constraints described above to identify Fraunhofer copies in detected images, and, from the identified Fraunhofer copies, compute depth information for the scene.

The disclosure of each of the following references is incorporated herein by reference in its entirety.

### REFERENCES

1. About face id advanced technology. https://support.apple.com/en-us/102381, accessed: 2024 Feb. 28 2
2. Alkhazragi, O., Dong, M., Chen, L., Liang, D., Ng, T. K., Zhang, J., Bagci, H., Ooi, B. S.: Modifying the coherence of vertical-cavity surface-emitting lasers using chaotic cavities. Optica 10 (2), 191-199 (February 2023) 8
3. Bajestani, S.E.M., Beltrame, G.: Event-based rgb sensing with structured light. In: Proceedings of the IEEE/CVF Winter Conference on Applications of Computer Vision. pp. 5458-5467 (2023) 5
4. Baudron, A., Wang, Z. W., Cossairt, O., Katsaggelos, A. K.: E3d: event-based 3d shape reconstruction. arXiv preprint arXiv: 2012.05214 (2020) 4
5. Besl, P. J., Mckay, N. D.: A method for registration of 3-d shapes. IEEE Trans. Pattern Anal. Mach. Intell. 14, 239-256 (1992), https://api.semanticscholar.org/CorpusID: 21874346 14
6. Bradski, G.: The OpenCV Library. Dr. Dobb's Journal of Software Tools (2000) 15
7. Brandli, C., Mantel, T. A., Hutter, M., Höpflinger, M. A., Berner, R., Siegwart, R., Delbruck, T.: Adaptive pulsed laser line extraction for terrain reconstruction using a dynamic vision sensor. Frontiers in neuroscience 7, 275 (2014) 4, 5
8. Chaney, K., Zihao Zhu, A., Daniilidis, K.: Learning event-based height from plane and parallax. In: Proceedings of the IEEE/CVF Conference on Computer Vision and Pattern Recognition Workshops. pp. 0-0 (2019) 3
9. Chang, C. T., Chen, P. W., Chin, W. L., Chou, S. H., Yang, Y. H.: Hardware-efficient algorithm and architecture design with memory and complexity reduction for semi-global matching. Integration 92, 99-105 (2023) 15
10. Dijk, T. v., Croon, G. d.: How do neural networks see depth in single images? In: Proceedings of the IEEE/CVF International Conference on Computer Vision. pp. 2183-2191 (2019) 1
11. Furgale, P., Rehder, J., Siegwart, R.: Unified temporal and spatial calibration for multi-sensor systems. In: 2013 IEEE/RSJ International Conference on Intelligent Robots and Systems. pp. 1280-1286 (2013). https://doi.org/10.1109/IROS. 2013.6696514 13
12 Gallego, G., Delbrück, T., Orchard, G., Bartolozzi, C., Taba, B., Censi, A., Leutenegger, S., Davison, A. J., Conradt, J., Daniilidis, K., et al.: Event-based vision: A survey. IEEE transactions on pattern analysis and machine intelligence 44 (1), 154-180 (2020) 2
13. Haghighi, N., Moser, P., Lott, J. A.: Power, bandwidth, and efficiency of single vcsels and small vcsel arrays. IEEE Journal of Selected Topics in Quantum Electronics 25 (6), 1-15 (2019) 8
14 Hernandez-Juarez, D., Chacón, A., Espinosa, A., Vázquez, D., Moure, J. C., López, A. M.: Embedded real-time stereo estimation via semi-global matching on the gpu. Procedia Computer Science 80, 143-153 (2016) 15
15. Hirschmuller, H.: Stereo vision in structured environments by consistent semi-global matching. In: 2006 IEEE Computer Society Conference on Computer Vision and Pattern Recognition (CVPR'06). vol. 2, pp. 2386-2393. IEEE (2006) 12
16 Hirschmuller, H.: Stereo processing by semiglobal matching and mutual information. IEEE Transactions on pattern analysis and machine intelligence 30 (2), 328-341 (2007) 12
17 Iwasa, T., Okumura, Y.: Long depth-range measurement for fringe projection photogrammetry using calibration method with two reference planes. Optics and Lasers in Engineering 151, 106940 (2022) 7
18. Kim, H., Leutenegger, S., Davison, A. J.: Real-time 3d reconstruction and 6-dof tracking with an event camera. In: Computer Vision-ECCV 2016: 14th European Conference, Amsterdam, The Netherlands, Oct. 11-14, 2016, Proceedings, Part VI 14. pp. 349-364. Springer (2016) 3
19. Ko, Y., Yi, S.: Development of color 3d scanner using laser structured-light imaging method. Current Optics and Photonics 2 (6), 554-562 (2018) 6
20. Lange, R., Seitz, P.: Solid-state time-of-flight range camera. IEEE Journal of quantum electronics 37 (3), 390-397 (2001) 1
21. Leroux, T., Ieng, S. H., Benosman, R.: Event-based structured light for depth reconstruction using frequency tagged light patterns. arXiv preprint arXiv: 1811.10771 (2018) 5
22. Levy, H.: Determining local depth from structured light using a regular dot grid (2019) 6
23. Li, Y., Jiang, H., Xu, C., Liu, L.: Event-driven fringe projection structured light 3d reconstruction based on time-frequency analysis. IEEE Sensors Journal (2024) 5
24. Lin, C. H., Wang, O., Russell, B. C., Shechtman, E., Kim, V. G., Fisher, M., Lucey, S.: Photometric mesh optimization for video-aligned 3d object reconstruction. In: Proceedings of the IEEE/CVF Conference on Computer Vision and Pattern Recognition. pp. 969-978 (2019) 4
25. Mangalore, A. R., Seelamantula, C. S., Thakur, C. S.: Neuromorphic fringe projection profilometry. IEEE Signal Processing Letters 27, 1510-1514 (2020) 5
26. Matsuda, N., Cossairt, O., Gupta, M.: Mc3d: Motion contrast 3d scanning. In: 2015 IEEE International Conference on Computational Photography (ICCP). pp. 1-10. IEEE (2015) 2, 4, 5
27. Morano, R. A., Ozturk, C., Conn, R., Dubin, S., Zietz, S., Nissano, J.: Structured light using pseudorandom codes. IEEE Transactions on Pattern Analysis and Ma-chine Intelligence 20 (3), 322-327 (1998) 6
28. Morgenstern, W., Gard, N., Baumann, S., Hilsmann, A., Eisert, P.: X-maps: Direct depth lookup for event-based structured light systems. In: Proceedings of the IEEE/CVF Conference on Computer Vision and Pattern Recognition. pp. 4006-4014 (2023) 5, 10
29. Muglikar, M., Gallego, G., Scaramuzza, D.: Esl: Event-based structured light. In: 2021 International Conference on 3D Vision (3DV). pp. 1165-1174. IEEE (2021) 2, 4, 5, 10
30. Pfrommer, B.: Frequency cam: Imaging periodic signals in real-time (2022) 13
31. Quigley, M., Mohta, K., Shivakumar, S. S., Watterson, M., Mulgaonkar, Y., Arguedas, M., Sun, K., Liu, S., Pfrommer, B., Kumar, V., et al.: The open vision computer: An integrated sensing and compute system for mobile robots. In: 2019 International Conference on Robotics and Automation (ICRA). pp. 1834-1840. IEEE (2019) 1
32. Rebecq, H., Gallego, G., Mueggler, E., Scaramuzza, D.: Emvs: Event-based multi-view stereo-3d reconstruction with an event camera in real-time. International Journal of Computer Vision 126 (12), 1394-1414 (2018) 3
33. Rocchini, C., Cignoni, P., Montani, C., Pingi, P., Scopigno, R.: A low cost 3d scanner based on structured light. In: computer graphics forum. vol. 20, pp. 299-308. Wiley Online Library (2001) 6
34. Schmidt, P., Scaife, J., Harville, M., Liman, S., Ahmed, A.: Intel® realsense™ tracking camera t265 and intel® realsense™ depth camera d435-tracking and depth. Real Sense (2019) 2, 6
35. Seurin, J. F., Ghosh, C. L., Khalfin, V., Miglo, A., Xu, G., Wynn, J. D., Pradhan, P., D'Asaro, L. A.: High-power high-efficiency 2d vcsel arrays. In: Vertical-Cavity Surface-Emitting Lasers XII. vol. 6908, pp. 45-58. SPIE (2008) 8
36. Sundar, V., Ma, S., Sankaranarayanan, A. C., Gupta, M.: Single-photon structured light. In: Proceedings of the IEEE/CVF Conference on Computer Vision and Pat-tern Recognition. pp. 17865-17875 (2022) 6
37. Szeliski, R.: A multi-view approach to motion and stereo. In: Proceedings. 1999 IEEE Computer Society Conference on Computer Vision and Pattern Recognition (Cat. No PR00149). vol. 1, pp. 157-163. IEEE (1999) 3
38. Tang, S., Zhang, X., Song, Z., Jiang, H., Nie, L.: Three-dimensional surface re-construction via a robust binary shape-coded structured light method. Optical Engineering 56 (1), 014102-014102 (2017) 1
39. Wang, G., Feng, C., Hu, X., Yang, H.: Temporal matrices mapping-based calibration method for event-driven structured light systems. IEEE Sensors Journal 21 (2), 1799-1808 (2020) 5
40. Wang, Z., Chaney, K., Daniilidis, K.: Evac3d: From event-based apparent contours to 3d models via continuous visual hulls. In: European conference on computer vision. pp. 284-299. Springer (2022) 4, 14
41. Wang, Z., Guo, J., Daniilidis, K.: Un-evmoseg: Unsupervised event-based independent motion segmentation. arXiv preprint arXiv: 2312.00114 (2023) 6
42. Zhang, Z.: Microsoft kinect sensor and its effect. IEEE multimedia 19 (2), 4-10 (2012) 2, 6
43. Zhou, Y., Gallego, G., Rebecq, H., Kneip, L., Li, H., Scaramuzza, D.: Semi-dense 3d reconstruction with a stereo event camera. In: Proceedings of the European conference on computer vision (ECCV). pp. 235-251 (2018) 4
44. Zhu, A. Z., Chen, Y., Daniilidis, K.: Realtime time synchronized event-based stereo. In: Proceedings of the European Conference on Computer Vision (ECCV). pp. 433-447 (2018) 4

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for depth extraction using diffractive structured light and an event-based camera, the method comprising:
projecting a plurality of channels of diffractive structured light into a scene, each channel including a plurality of Fraunhofer copies resulting from passing light from a light source through a diffractive optical element;
detecting, using an event-based camera, light reflected from the scene; and
determining depth measurements of the scene from the light detected by the event-based camera using a processing pipeline calibrated using minimum and maximum depth constraints for each channel to disambiguate the Fraunhofer copies in the light detected by the event-based camera.

2. The method of claim 1 wherein projecting the plurality of channels of diffractive structured light into the scene comprises, for each channel, passing coherent light through the diffractive optical element to produce the Fraunhofer copies.

3. The method of claim 2 wherein the Fraunhofer copies comprise lines visible in the diffractive structured light formed by passing the coherent light through slits in the diffractive optical element.

4. The method of claim 1 wherein detecting the light reflected from the scene includes detecting the light synchronously with projection of the light for each of the channels.

5. The method of claim 1 wherein the processing pipeline includes a Fraunhofer copy lookup table that enables the Fraunhofer copies to be identified in the light reflected from the scene and a depth lookup table that contains depth values corresponding to coordinates of the identified Fraunhofer copies.

6. The method of claim 1 wherein determining the depth measurements includes computing refined depth measurements by comparing events occurring at pixels at corresponding spatial locations in different channels.

7. A system for depth extraction using diffractive structured light and an event-based camera, the system comprising:
a structured light projector including a light source and a diffractive optical element for projecting a plurality of channels of diffractive structured light into a scene, each channel including a plurality of Fraunhofer copies resulting from passing light from the light source through the diffractive optical element;
an event-based camera for detecting light reflected from the scene; and
a processing pipeline for determining depth measurements of the scene from the light detected by the event-based camera, wherein the processing pipeline is calibrated using minimum and maximum depth constraints for each channel to disambiguate the Fraunhofer copies in the light detected by the event-based camera.

8. The system of claim 7 wherein the structured light projector is configured to, for each channel, pass coherent light through the diffractive optical element to produce the Fraunhofer copies.

9. The system of claim 8 wherein the Fraunhofer copies comprise lines visible in the structured light formed by passing the coherent light through slits in the diffractive optical element.

10. The system of claim 7 wherein the event-based camera is configured to detect the light synchronously with projection of the light for each of the channels.

11. The system of claim 7 wherein the processing pipeline includes a Fraunhofer copy lookup table that enables the Fraunhofer copies to be identified in the light reflected from the scene and a depth lookup table that contains depth values corresponding to coordinates of the identified Fraunhofer copies.

12. The system of claim 7 wherein the processing pipeline is configured to compute refined depth measurements by comparing events occurring at pixels at corresponding spatial locations in different channels.

13. A non-transitory computer readable medium having stored thereon executable instructions that when executed by a processor of a computer control the computer to perform steps comprising:
controlling a structured light projector to project a plurality of channels of diffractive structured light into a scene, each channel including a plurality of Fraunhofer copies resulting from passing light from a light source through a diffractive optical element;
controlling an event-based camera to detect light reflected from the scene; and
determining depth measurements of the scene from the light detected by the event-based camera using a processing pipeline calibrated using minimum and maximum depth constraints for each channel to disambiguate the Fraunhofer copies in the light detected by the event-based camera.

14. The non-transitory computer readable medium of claim 13 wherein controlling the structured light projector to project the plurality of channels of diffractive structured light into the scene comprises controlling the structured light projector to, for each channel, pass coherent light through the diffractive optical element to produce the Fraunhofer copies.

15. The non-transitory computer readable medium of claim 14 wherein the Fraunhofer copies comprise lines visible in the diffractive structured light formed by passing the coherent light through slits in the diffractive optical element.

16. The non-transitory computer readable medium of claim 13 wherein controlling the event-based camera to detect the light reflected from the scene includes controlling the event-based camera to detect the light synchronously with projection of the light for each of the channels.

17. The non-transitory computer readable medium of claim 13 wherein the processing pipeline includes a Fraunhofer copy lookup table that enables the Fraunhofer copies to be identified in the light reflected from the scene and a depth lookup table that contains depth values corresponding to coordinates of the identified Fraunhofer copies.

18. The non-transitory computer readable medium of claim 13 wherein determining the depth measurements includes computing refined depth measurements by comparing events occurring at pixels at corresponding spatial locations in different channels.
